(19) United States
(12) Patent Application Publication
(10) Pub. No.: US 2007/0078773 A1
(43) Pub. Date: Apr. 5, 2007

(54) Posting digital media

(76) Inventor: Arik Czerniak, Herzlia (IL)

Correspondence Address: Eitan Law Group;c/o Landon IP Inc., Suite 450, 1700 Diagonal Road, Alexandria, VA, 22314, US

(21) Appl. No.: 11/513,007

(22) Filed: Aug. 31, 2006

Related U.S. Application Data
(60) Provisional application No. 60/712,424, filed on Aug. 31, 2005.

(51) Int. Cl. G06Q 99/00

(52) U.S. Cl. 705/57; 705/59

(57) ABSTRACT

There is provided a method of posting online digital media content, the method may include receiving a digital media content and determining availability of associated posting copyright. The method may further include posting received digital media content, and/or modification(s) thereof, if copyright is available and under certain limitations or restrictions specified in, or imposed by, a posting licensing policy acceptable by associated copyright issuer(s) and a media distributor. There is also provided a digital media content posting system for implementing the online digital media content posting method.

### FIELD OF THE DISCLOSURE

The present disclosure relates to the field of digital media content distribution over a data network such as the Internet. More specifically, the present disclosure relates to the distribution of digital media content and media derivatives based on a mass licensing policy.

### BACKGROUND

Data networking and transferring data over data networks continue to develop hand-in-hand. That is, the more sophisticated data networking gets the faster digital files can be transferred between any two locations connected to a common data network. Technological improvements in digital media and in the ways digital media can be accessed or communicated, for example over the Internet and/or cellular-based communication infrastructure, result in more and more digital content being submitted and consumed by millions of individual users and content/service providers through out the world. Technological improvements continue to facilitate the creation of a wide variety of digital content and services in audio, visual, and audiovisual contents (hereinafter referred to collectively as “audiovisual content”) that are sent to customers through various media devices. Thanks to technological improvements, Internet users, Internet websites and others can easily copy short segments of copyright protected and non-copyright protected digital content, and distribute these segments over the Internet, for example, or by using other kinds of communication systems, for example by attaching them to an e-mail or by forwarding them using peer-to-peer software.

There are artistic, musical, dramatic, and other kinds of works that are not allowed to be freely copied due to them being copyright protected. However, the amount of digital content to be handled by the content providing companies is usually immense and it is very difficult for companies or copyright issuers to enforce copyright laws, partly because of the difficulties involved in tracking the distribution of such works. Therefore, maintaining the copyrights, and in particular generating revenues from distributed copyright protected artistic works, is of a major concern, especially for copyright issuers.

Another contribution to the lack of enforcement of copyright laws is made (sometimes unintentionally) by digital content distributors because, up until today, digital content providers and distributors have been incapable of separately dealing with each copyright issuer and each piece or derivative of copyrighted work, for which reason thousands of works have been (and are still being) distributed per month, without having these works distribution negociated first with the involved lawful copyright issuers.

As far as the media content distributors are concerned, they are not willing to pay copyright owners or issuers a large fixed amount of money that is not directly related to, reflective of, or otherwise correlated to, the posting of specific content items or media derivatives. In other words, media content distributors are not willing to pay money for content items or media derivatives which are not consumed by many users, and therefore yield less revenues (such content items and media derivatives being referred to herein as “unpopular” content items/media derivatives).

Therefore, there has been long-felt need in the field to formulate a media posting licensing method, by which copyrights may be easily maintained, essentially regardless of the size and amount of the involved digital content.

### GLOSSARY

“Copyright” is generally a legal tool that gives the creator of a literary, artistic, musical, or other creative work the sole right to publish and sell that work. Copyright owners and issuers have the right to control and regulate the reproduction and distribution or posting of their work, including the right to receive payment for that reproduction and distribution/posting. Authors, originators and creators may grant or sell those rights to others, including publishers, distributing or recording companies. As the media on which artistic and intellectual works are recorded have changed with time, copyright protection has been extended from the printing of text to many other means and forms of recording original expressions. Besides books, stories, poems, and other printed literary works, copyright may subsist in a wide range of creative, intellectual, or artistic forms or “works”. For example, copyright may protect computer programs; musical compositions; song lyrics; dramas; pictorial, graphic, paintings, drawings, photographs, sculptural works; architectural works; pantomimes and choreographic works; movies, musical compositions, audio recordings, paintings, drawings, photographs, radio and television broadcasts of live and other performances, motion pictures and other audiovisual works.

“Work” generally refers herein to audiovisual digital content (referred to herein as a “content item”) protected according to copyright law, where an audiovisual content may be a digital media file that may include, for example, picture(s), video stream(s), audio/music content, audiovisual content, text, film(s), television (TV) show(s) or programs, new(s), sport(s), educational clip(s), video trailer(s), video advertisements, video animations, presentations, image galleries, ring tones, single content file (for example a single video clip or piece of music), and so on.

“Derivative work” (also referred to herein as “media derivative”) is generally an artistic creation that may include major, basic copyrighted aspects of an original, previously created from a first work or content item. In the context of the present disclosure making, creating, deriving or generating a “media derivative” from content item(s) or from other, media derivative(s) generally means imposing or applying one or more restrictions on content item(s) and/or media derivatives, including, but not limiting, aggregating one or more content items and/or media derivatives, modifying the involved content item(s) and/or media derivative(s) in such a way that the resultant media derivative is the required or desired one (such as required or desired according to a predtermined posting licensing policy). In general, restrictions (such as temoral, bit-wise, and so on) may define which segment(s), portion(s), truncation(s), bit rate(s), minimum and/or maximum length(s) of segments, truncations and portions, clip(s), new compilation(s) of content items, type of digital media (for example image, text, song, motion picture), and so on, make a media derivative distributable or postable.

“User” (also referred to herein as “client”) generally refers herein to a person consuming digital content item(s) through a packet-switched network such as the Internet, or any other data or communication system.

“Licensing policy” (also referred to herein as “posting licensing policy”) is a general term refering herein to a set, collection or aggregation of terms, definitions, conditions and/or circumstances, under which a copyright issuer (a licensor) allowes a distributor (a “licensee”) to post copyrighted content items and/or media derivatives to clients. Put differently, licensing policy, which may be a digital content posting policy agreed by a copyright issuer and a digital media distributor, may define which copyrighted content items and/or media derivative(s) the digital media distributor is allowed to post, and also the way(s) copyrighted content items and media derivatives may be distributed. For example, a media derivative conforming to a “5-second music piece” criterion, or restriction, may be posted if the “predefined 5-second music piece” criterion is defined in the licensing policy. If a given media derivative criterion is defined in the licensing policy, the digital media distributor is allowed (licensed) by the copyright issuer (the licensor) to post substantially any piece of work belonging to or originating from the copyright issuer, which conforms to the aforesaid media derivative criterion or restriction. In addition, a content item or a media derivative may be allowed, according to an exemplary agreed-upon posting licence, to be posted to users only through certain web sites and telephone companies. A licensing policy may further include a business/revenue agreement associated with the distribution of content items and media derivatives to users. Usually, a media derivative of a copyrighted content item is also copyright protected.

“Posting copyright” refers herein to the existence of copyright or copyrights which is/are associated with a content item, or a derivative thereof, or any other media derivative, that is intended to be posted by a licensed distributor (the “licensee”). Accordingly, “checking availability of posting copyright”, in respect of a given content item or media derivative, means herein checking whether copyright or copyrights are associated with the given content item (or media derivative). “Posting” also means herein “distributing” and “retailing”.

“Digital Rights Management” or DRM (also called Digital Restrictions Management) is an umbrella term for any of several technologies used to enforce pre-defined policies for controlling access to digital data (such as software, music, movies) and hardware. In more technical terms, DRM handles the description, layering, analysis, valuation, trading, monitoring and enforcement of usage restrictions that accompany a specific instance of a digital work. DRM is more fully described, for example in the wewbsite of Wikipedia (the free encyclopedia); “Digital Rights Management (DRM) Architectures” (D-Lib Magazine, June 2001, Volume 7, Number 6 ISSN 1082-9873); “Digital Rights Management and Copy Protection Schemes”; and in “A Guide to Digital Rights Management” (published by the Australian Government, Department of Communications, Information Technology and the Arts), the content of which are incorporatd herein by reference in their entirety.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

As part of the present disclosure a method of posting online digital media content (such as content items and media derivatives) is provided, which may include receiving digital media content and determining availability of associated posting copyright. According to an embodiment of the present disclosure determining the availability of posting copyright may include determining the identity of a copyright issuer (herein a “licensor”) associated with the received digital media content. Posting licensing policy, which may be accepted by both the digital content distributer (herein a “licensee”) and a licensor, may be used for distributing content items and/or media derivatives, and, responsive to the determination that posting copyright is available (such as by identifying the identity of the received content's licensor), the content may be posted to clients using, or according to, the posting licensing policy.

According to an embodiment of the present diosclosure the licensee may provide the licensor, per content item and media derivative, with business (and others, such as statistics-wise) information regarding content items and media derivatives, and the distribution thereof. The information may include, for example, detailed descriptions of content items and media derivatives involved, the number of times a given content item and/or media derivative was already distributed, distribution way(s) and revenues incurred for each distributed content item and/or media derivative.

There is provided, in accordance with an embodiment, a method of posting online a content item, the method may include receiving a content item and automatically determining availability of posting copyright for the content item. The method may further include posting the received content item if copyright is available.

As part of the present disclosure a digital media content posting system is provided, which system may include a communication module, adapted to receive content items and media derivatives, and a copyright clearance module adapted to determine availability of posting copyright associated with a received content item or media derivative, and post the content item or media derivative according to a posting licensing policy associated with an available posting copyright. Determine may include determining an identity of the received content copyright issuer. Determine may include determining whether a received content item or media derivative conforms to one or more restrictions specified in a posting licensing policy. In an embodiment of the present disclosure the copyright clearance module may be further adapted to modify a content item, media derivative of a content item, or both, according to one or more restrictions defined in, or imposed by, the involved posting licensing copyright. In an embodiment of the present disclosure the copyright clearance module may be further adapted to send a posting report to respective copyright issuers. The copyright clearance module may be further adapted to automatically determine availability of associated posting copyright or the identity of a associated copyright issuer(s).

In an embodiment of the present disclosure the posting system may further include a posting module adapted to post a content item and media derivative if copyright is available and/or if the content item and/or media derivative conform(s) to one or more restrictions specified in the posting licensing policy. According to an embodiment of the present disclosure the copyright clearance module may perform some, preferred, or all of the tasks intended for, or mentioned in connection with, the posting module.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustarted in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates a general layout and functionality of a content posting system;

FIG. 2 schematically exemplifies a content posting system; and

FIG. 3 shows an exemplary flow chart.

It will be appreciated that for simplicity and clarity of illustration, elements shown in the figures have not necessarily been drawn to scale. For example, the dimensions of some of the elements may be exaggerated relative to other elements for clarity. Also, at times singular or plural (or options between singular and plural) may be described, however, notations or descriptions of singular include, or is to be construed as, plural, and plural include, or is to be construed as singular where possible or appropriate.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present disclosure may include apparatuses for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachin7gs of the disclosure s as described herein.

A licensee and licensor do not necessarily agree on or specify beforehand which media derivatives will be distributed but, rather, they may agree on or specify them at later stage while, or after, the media content item(s) and derivatives are released for, or posted to, users.

There is provided, in accordance with some embodiments, a method of posting online a content item, the method includes, receiving a content item and automatically determining availability of posting copyright for the content item. The method may further include posting the received content item if copyright is available. The method may further include posting the received content item if copyright is available.

Determining availability of posting copyright may include determining an identity of the received content copyright issuer. Determining availability of posting copyright may also include determining whether a received content item conforms with restriction(s) set forth in a posting licensing policy.

The method may further include posting a media derivative of the content item if the media derivative conforms with restriction(s) set forth in a posting licensing policy. A content or a derivative thereof may be posted to users directly or through a retailer. A retailer may include a mobile phone company, television broadcasting network, interactive television providing company, Internet web site or any combination thereof. The method may further include sending posting reports to respective copyright issuers.

There is further provided, according to some embodiments, a content posting system, which may include a communication module, adapted to receive a content item and a copyright clearance module adapted to automatically determine availability of posting copyright. Automatically determine may include determining an identity of the received content copyright issuer. Automatically determine may include determining whether a received content item conforms with restriction(s) set forth in a posting licensing policy. The copyright clearance module may further be adapted to determine whether a media derivative of the content item conforms to restriction(s) set forth in a posting licensing policy.

The system may further include a posting module adapted to post received content items and/or media derivatives, or modification(s) thereof, if copyright is available and/or if content items and/or media derivatives, and/or modification(s) thereof, conform to one or more restrictions specified in, or imposed by, the involved posting licensing policy. The posting module may be further adapted to post a content item or a media derivative to users directly or through a retailer. A retailer may be a mobile phone company, television-broadcasting network, interactive television providing company, Internet web site or any combination thereof.

The copyright clearance module may be further adapted to modify a content item, a media derivative of a content item or both according to one or more restrictions defined in the posting copyright. The system may further adapted to send posting reports to respective copyright issuers.

As part of the present disclosure a media derivative licensing standard (MDLS) method is provided, which may be used for licensing, posting, distributing or retailing, copyrighted content items and media derivatives, wherein a licensor (which may be, for example, a company or a user that may be copyright owners or issuers) may grant a licensee (which may be, for example, a media content distributor or a content or media company) a permission to post content items and media derivatives according to an agreed-upon licensing policy. The licensee may select for posting (from a pool of content items and media derivatives) specific content items and/or media derivatives. In general, the licensor and licensee may agree what a valid or legitimate (postable) media derivative is. Such an agreement may be based, for example on length, quality, bit-wise or time-wise size, bit rate, or any other measurable aspect and/or restrictions.

Responsive to a determination that posting copyright is available (such as by identifying the identity of the received content's licensor) for a given content item or media derivative, the content item or media derivative may be posted, or otherwise rendered accessible, to users using, or according to, the predefined licensing policy. The licensee (the distributor) may provide the licensor with information related to posted content items and media derivatives, such as a break down of posted (consumed) content items and media derivatives, number of times each content item and media derivative was distributed, revenues ensued, and so forth. According to an embodiment of the present disclosure licensees and licensors do not have to specify beforehand which specific content item or media derivative will be distributed under the licensing policy.

The licensee may have, keep, manage, or otherwise handle, a bank or pool of content items and/or media derivatives that may be provided (for example by users) to the licensee's web site (for example), and/or to a storage array accessible by the licensee. The licensee may post content items and/or media derivatives through different media channels as long as the posted content items and media derivatives satisfy the requirements or restrictions defined by a permission granted by the licensor, or in a licensing policy agreed-upon by both sides (the distributor or licensee, and the copyright issuer or licensor).

According to an embodiment of the present disclosure a licensed copyrighted content item or media derivative may substantially be in any form, including, for example, film; television (TV) shows; news, sports (news and events) and/or educational clips; video clips, advertisements, musicals, advertisements and/or animations trailers; presentations, image galleries, music, ring tones, or any other media content format known today or that will be devised in the future.

According to an embodiment of the present diosclosure licensed media may be distributed, for example, as picture(s), video stream(s), audio/music content, audiovisual content, text, film(s), television (TV) show(s) or programs, new(s), sport(s), educational clip(s), video trailer(s), video advertisements, video animations, presentations, image galleries, ring tones, single content file (for example a single video clip or piece of music).

According to an embodiment of the present diosclosure a content item and media derivative may be directly or indirectly identified or detected by the licensee by using any method including, but not limited to, professional editors, amateur, software systems, community and collaborative filtering. According to an embodiment of the present diosclosure a media derivative may be defined by its content length, time length, content quality, size or any other form of gauging segments of the original work (content). According to an embodiment of the present diosclosure the licensee may protect distributed media derivatives by using a Digital Rights Management (DRM) system. “Professional editor” may generally refer to any software application or tool adapted to, or specifically designed to, identify or recognize specified kinds of data (for example copyright issuers) associated with, or contained within, a content item and/or media derivative. “Amateur editor” may generally refer to manually (by a user or client, for example, or by expert persons) identifying or recognizing specified kinds of data (for example copyright issuers) associated with, or contained within, a content item and/or media derivative.

According to an embodiment of the present disclosure a licensee may pay a licensor a given royalty per media derivative, per global price, per periodical price, per revenue sharing or per any, but not limited to any, combination thereof. According to an embodiment of the present disclosure the licensee may license a media derivative of the work which is distributed by the licensee as a part of a compilation of other media derivative(s) or segment(s), such as when a montage, or some mix effect (for example), is required or desired.

According to an embodiment of the present disclosure a content item and a media derivative may be identified by the licensee by using any method including, for example, professional editors, amateur editors, software applications, community and collaborative filtering, directly or indirectly.

According to an embodiment of the present disclosure a content item and media derivative may be limited, restricted or defined, by time length (for example 30 seconds), content quality, Quality of Service (QoS), (binary) bit-wise size (for example 20 bytes), file size (in binary bytes), bit-rate (for example 1,500 bits-per-second (bps)) or any other form of measurable aspect of, associated with original media content and/or to the streaming of the original media content through the associated communication network.

According to an embodiment of the present disclosure a licensee may provide one or more licensors with a detailed report regarding the selection of content items and media derivatives and the extent of their distribution and ensuing posting revenues. A licensee may pay the licensor fees and/or royalties as a fixed fee per content item and media derivative, global fee, periodical fees, revenue sharing or per any combination thereof, and/or fees and/or royalties according to other or additional criteria. In an embodiment of the present disclosure the licensee may use a digital rights management (DRM) system to protect content items and media derivatives from being used by unauthorized users. In an embodiment of the present disclosure the licensee may distribute a content item or derivative thereof as part of a compilation (montage, mix, and so on) of other content items and/or media derivatives.

The MDLS licensing and posting method may assist copyright owners or issuers and media content distributors in establishing a mutually accepted distribution relationships that will enable both of them to benefit from distribution of media content, while eschewing the hassle usually involved in having to choose, beforehand, what content items and media derivatives to distribute, and negotiate specific and separate deals for each content item and media derivative.

The MDLS system (the content posting system) may also provide licensors with a turnkey solution for distributing content items and media derivatives, while reducing risks and costs by effectively outsourcing editorial operations, building distribution venues and tracking distribution information. The MDLS system may provide licensees and distributors with a method of contracting with multiple licensors, while reducing negotiations time, and commitment levels. The MDLS system may help works creators and distributors to cooperate in this new arena of segmented, derivative media, by regulating the process involved in the licensing of copyrighted content items and media derivatives, and providing, or offering, a legal framework to operate without abusing copyright laws. Exemplary posting licensing policies and their use will now be demonstrated using the following examples.

### EXAMPLE 1

1. A TV network called XYZ has produced 5 seasons of a TV show called “theTVshow”, which is distributed on TV, syndicated, and sold on DVD's in retail stores.
2. FGH, a mobile (cellular phone) content distributor (or content provider) asks TV network XYZ to formulate a licensing policy under which content provider FGH would be allowed to distribute media derivatives of “the TV show” over a European mobile network (for example).
3. TV network XYZ and content distributor FGH agree that content distributor FGH can distribute media derivatives of “the TV show” under the following (MDLS) license provisions (or licensing policy):
   a. Each segment of “the TV show” distributed by content distributor FGH will be 3 minutes long or shorter.
   b. Content distributor FGH will provide TV network XYZ with a monthly report that specifies the number of segments distributed and, in addition, a short description and a copy of each distributed segment.
   c. Content distributor FGH will pay TV network XYZ a fixed price of 1 cent (for example) for each distributed segment.
   d. Content distributor FGH will pay TV network XYZ, as royalty, 25% of the gross revenue earned per given period.
4. Content distributor FGH identifies 10 different segments of the “the TV show” that are 3-minute long or shorter. Content distributor FGH may identify the segments either automatically (by using any editor software tool or application), or manually.
5. During the first month, content distributor FGH distributes the 10 segments a total of 200,000 times to mobile phone users thought Europe, and each user pays 50 American cents (for example) for each downloaded segment. Content distributor FGH, therefore, has a gross revenue of 200,000×0.5=US$100,000
6. At the end of the month, content distributor FGH provides TV network XYZ with a list and copy of each segment that was distributed during the last month and pays TV network XYZ US$2,000 (200,000×US$0.01) as fixed price, plus 25% of the gross revenues (US$25,000) as royalty.

### EXAMPLE 2

1. A film producer called SDF has produced a motion picture called “the Film”, which is shown at cinemas, syndicated, and sold on DVD's in retail stores.
2. XCV, an internet streaming video content site (a content distributor or provider) asks film producer called SDF to formulate a licensing policy under which content distributor XCV would stream segments of “the Film”.
3. SDF and XCV agree that SDF will distribute the content under the following MDLS license provisions (or licensing policy):
   a. The segments of “the Film” distributed by FGH, will be 5-minute long or shorter and, in addition, the data streaming rate will not exceed a bitrate of 300 kilo bits per second (kbps).
   b. XCV will provide SDF with a monthly report that specifies the number and a description of streamed segments, and a copy of each streamed segment.
   c. XCV will pay SDF a fixed price of 25 American cents per streamed segment.
4. Fifteen different segments of the “the Film” motion picture were submitted by 15 or more (two or more user may submit the same segment) users with XCV.
5. During the first month, XCV streams the 15 different segments a total of 1,000,000 times to user connected to its site.
6. At the end of the month, XCV provides SDF with a list and copy of each streamed segment and pays SDF the total amount of US$250,000 (1,000,000×US$0.25).

Usually, the licensor's interest is to give the licensee the largest freedom of action possible to distribute as many digital content as possible (as long as the licensee keeps the licensor's interests, for example as defined in the licensing agreement) in order to maximize the return on the investment made in the creation of the digital content, by maximizing profits associated with the distribution of such digital content.

Since the licensee may often have numerous copyright owners to cooperate with, s/he may have to negotiate and agree on MDLS policy (posting policy) with each copyright owner or issuer before the licensee starts to distribute content items and/or media derivatives. However, once a MDLS policy has been agreed by the licensee and each copyright owner, the licensee may distribute, per given time period, numerous copyrighted content items and media derivatives which may be associated with different copyright owners or issuers.

Instead of buying (at relatively high prices) many content items and media derivatives from media companies and distribute all of them and find only later which content items and/or media derivatives are the most popular, the digital content provider or digital content distributor may be quite certain that its users fill with, or forward to, its content items and derivatives pool only, or mostly, the more attractive or popular digital content, including content items and media derivatives. The latter assumption is reasonable because users who submit digital content are also the potential consumers of such or like digital content. This way, a licensee may only have to pay licensing fees (to the licensor(s), or copyright issuer(s)) which are associated with the “good stuff”.

The licensee, who may have stored or kept in his/her content items and media derivatives pool numerous content items and media derivatives which were submitted, for example by users and legally (in terms of copyrights) belong to the licensor, may distribute, through different media channels (for example through mobile, interactive TV, Internet web sites, and so on) any of this media content as long as this media content satisfies or conforms to the defined MDLS standards (the licensing terms or policy), without having to communicate with the licensor (or each licensor, whichever the case may be) for each content item or media derivative individually.

### EXAMPLE 3

Company X has an Internet web site for consuming and posting digital media content. Company X has associated with it 5,000,000 users who can access thousands of content derivatives through company X web site. These users can also independently and freely add their favorite media content (or, in general, media content of their choice) to the the content bank or content pool in the company's web site, in order to share them with other users. Company X monitors ingress and egress digital content streams and maintains statistical data relating to the popularity of content items and media derivatives. In general, the more a content item (or media derivative, for that matter) is consumed by users, the more popular the content item (or media derivative) is.

The popularity of a content item or media derivative, or an indication thereof, may be found or obtained, for example by asking pre-selected users to review and rank the content item or media derivative. Ranking may then be evaluated in various ways, for example by averaging ranking or assigning fixed or dynamically changing weights to different rankings or different users.

Company X wishes to license its digital content in order to retail it, for example through mobile telephone companies and web sites, and also through or by using interactive TV systems. Content managers of company X notice that a media company called Y (a large media corporation producing TV shows, films, commercials, and so on) owns copyrights for many of the more popular content segments in Company X web site.

Companies X and Y sign a licensing agreement that will allow company X to distribute media content associated with company Y under the following (MDLS) restrictions, or in accordance with the agreed-upon licensing policy the (exemplary) terms of which may be, for example, the following:
1. Distributed content items and media derivatives will be 2-minute long or shorter.
2. The Logo of Media company Y will be incorporated in all of the visual distributed content segments associated with company Y.
3. Company X is allowed to generate revenues by retailing content segments associated with company Y only through mobile companies.
4. Company X is allowed to distribute content segments associated with media company Y for non-profit purposes only through company X web site, but not through other Internet web sites. That is, company X is not entitled (according to the exemplary licensing policy) to distribute company Y's content items and media derivatives through Internet web sites other than its own.

Once in effect, the foregoing licensing policy allows company X to select any one or more of the content items and/or media derivatives stored, for example in its web site, which are copyrighted by (or the copyrights of which belong to, or otherwise associated with) Media Company Y; modify it/them (provided that there is no discrepancy as far as the licensing policy is concerned); and retail them through mobile telephone companies, and so on (as specified in the licensing terms) without having to individually get media company Y approval for each media derivative. Assuming that the popularity of content items (or derivatives thereof) is known to company X (for example by asking users to rank them), company X may retail only, or mainly, the most popular content items and/or media derivatives in its content items pool and eschew spending resources (computer's and others) on unpopular, less popular, or on the least popular, content items and media derivatives.

The ability to select for retail only popular content items and media derivatives allows both Companies X and Y to maximize revenues, and, in addition, users may consume the more popular content items and/or media derivatives, for example through their mobile phone, which is allowed according to the foregoing licensing policy. As agreed by both sides (as part of the exemplary licensing policy), by the end of each month company X has to send a posting/distribution report to Media Company Y. Such a report may include the following exemplary particulars:
1. The number of content items and medias derivatives retailed is 500,000.
2. Total revenues: US$1,000,000.
3. Company X's share in the total revenues: US$500,000.
4. Media Company Y's share in the total revenues: US$ 500,000.

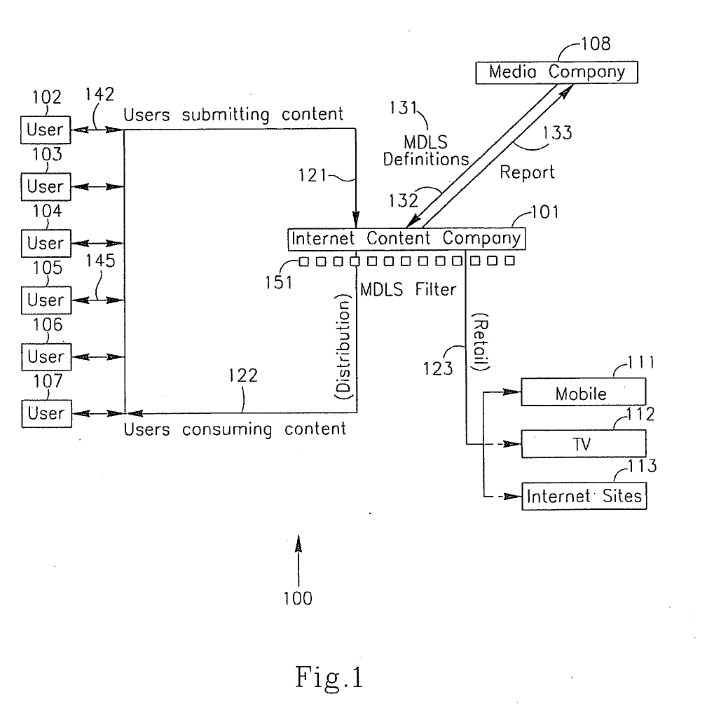

Referring now to FIG. 1, a general layout and functionality of content posting system (generally shown at 100) is shown and described according to an embodiment of the present disclosure. Internet Content Company 101 may be any web site that stores, or is capable of storing, content items and media derivatives which may be received (shown at 121), for example from users such as exemplary users User 102, 103, 04, 105, 106 and/or 107. The stored content items constitute a pool of content items that is managed or handled by, or is associated with, Internet Content Company 101, and from which content items pool any user(s) from Users 102 through 107, and possibly other users, may consume for personal use. Internet Content Company 101 may have a licensing agreement (“MDLS Definitions”, shown at 131) with (shown at 132) Media Company 108 that allows Internet Content Company 101 (that gives a license to Internet Content Company 101) to distribute (shown at 122) content items, or a selection or media derivatives thereof, to one or more users from User 102 through 107 and/or to other users (not shown). Providing to user(s) (or consuming by user(s)) a media content that is a derivative of one or more stored content items is herein referred to generally as providing the media content through an MDLS filter (“MDLS Filter”, shown at 151). Put differently, a content item (or a derivative thereof) will not pass through MDLS Filter 151 unless the content item (or the derivative thereof, respectively) satisfies MDLS Definitions 131.

Internet Content Company 101 may also retail (shown at 123) content items, or a selection or media derivatives thereof, to or through one or more mobile telephone companies (collectively referred to herein as “Mobile”, shown at 111), one or more TV broadcasting stations (collectively referred to herein as “TV”, shown at 112), one or more Internet web sites (collectively referred to as herein “Internet Sites”, shown at 113), and/or to or through other companies, service providers, (subsidiary) content providers, and so on.

At prescribed times, which may be specified in the posting or licensing policy, Internet Content Company 101 may issue and send (shown at 133) to Media Company 108 a posting or distribution report that may include information regarding content items and media derivatives that were posted or distributed from the time the licensing policy became effective or from the time the last posting report was sent to Media Company 108, whichever relevant.

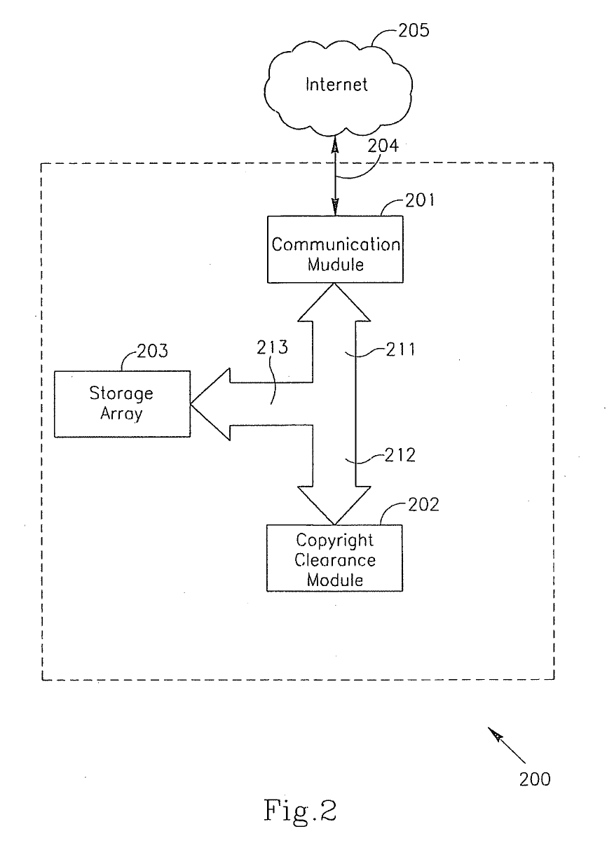

Referring now to FIG. 2, a content posting system (generally shown at 200) of a content company is shown and described according to an embodiment of the present disclosure. Content posting system 200 may include a communication module (shown at 201), a copyright clearance module (shown at 202) and a storage array (shown at 203).

Communication module 201 may be adapted to receive and post (shown at 204) content items and content item derivatives, for example over a packet-switched network such as Internet 205. Content items and content item derivatives may be voluntarily forwarded to communication module 201 by users and stored in storage array 203.

Copyright clearance module 202 may be adapted to automatically determine, per received (on-the-fly or at a later stage) and/or stored content item and media derivative, availability of posting copyright. Copyright clearance module 202 may need to determine the availability of a posting copyright in order to decide (among other things) whether the involved content item or media derivative is subject to restrictions posed by a copyright agreement or copyright policy. If the involved content item or media derivative is subject to a copyright agreement or copyright policy such as MDLS Definitions 131 of FIG. 1, the content item or media derivative, or modification(s) thereof, will not pass through MDLS Filter 151 (for example) unless the content item or media derivative, or the modification thereof, satisfies or conforms to the copyright agreement or copyright policy (for example MDLS Definitions 131 of FIG. 1). Copyright clearance module 202 may also be adapted to determine an identity of the received content copyright issuer in the ways described herein.

Copyright clearance module 202 may be further adapted to modify a received content item and a media derivative according to one or more restrictions defined in a posting copyright, posting license or licensing policy. Copyright clearance module 202 may be further adapted to cause a posting report to be issued and forwarded (such as shown at 133 in FIG. 1, and at 204 in FIG. 2), through a communication module such as Communication Module 201, to a content's copyright issuer such as Media Company 108 of FIG. 1. In an embodiment of the present disclosure copyright clearance module 202 may issue the posting report on its own or by itself.

According to an embodiment of the present disclosure each content item and media derivative received (shown at 204) by Communication Module 201 may first be stored (shown at 213) in Storage Array 203 and thereafter forwarded (shown at 212) to Copyright Clearance Module 202 for determining the availability of a posting copyright. If Copyright Clearance Module 202 determines that a posting copyright is available, Copyright Clearance Module 202 may check whether the involved stored content item or media derivative, or a modification thereof, satisfies the licensing agreement or policy (for example MDLS Definitions 132). If the involved stored content item or media derivative, or the modification thereof, satisfies the licensing agreement or policy, Clearance Module 202 may forward (shown at 211) the content item or media derivative, or the modification thereof, to Communication Module 201, and Communication Module 201 may post (shown at 204) the content item or media derivative, or the modification thereof, to users of Internet 205, for example.

According to another embodiment of the present disclosure each content item and media derivative received (shown at 204) by Communication Module 201 may first be forwarded (shown at 212) to Copyright Clearance Module 202 to determine whether a posting copyright is available. If Copyright Clearance Module 202 determines that a posting copyright is available, Copyright Clearance Module 202 may check whether the involved stored content item or media derivative, or a modification thereof, satisfies the licensing agreement or policy (for example MDLS Definitions 132). If the involved stored content item or media derivative, or the modification thereof, satisfies the licensing agreement or policy, Clearance Module 202 may forward (shown at 213) the content item or media derivative, or the modification thereof, to Storage Array 203 and concurrently to Communication Module 201, for posting (shown at 204) the content item or media derivative, or the modification thereof, to users of Internet 205, for example.

Alternatively, if the involved stored content item or media derivative, or the modification thereof, satisfies the licensing agreement or policy, Copyright Clearance Module 202 may forward (shown at 213) the content item or media derivative, or the modification thereof, to Storage Array 203 and only at a later stage to Communication Module 201 for posting (shown at 204) it to users of Internet 205, for example, or to users through retail agents such as exemplary Mobile 111, TV 112 and/or Internet Sites 113 of FIG. 1. By “at a later stage” is generally meant herein after the reception of the involved content item or media derivative.

Although storage array 203 is shown as an integral part of content posting system 200, storage array 203 may be a stand-alone memory device or memory system, or it may reside in, or be an integral part of, a remote system. Storage array 203 may include a memory area or space dedicated for copyrighted content items and media derivatives, and another area that is dedicated for non-copyrighted content items and media derivatives. Alternative embodiments may include more modules, less modules, other modules, and/or functionally equivalent modules.

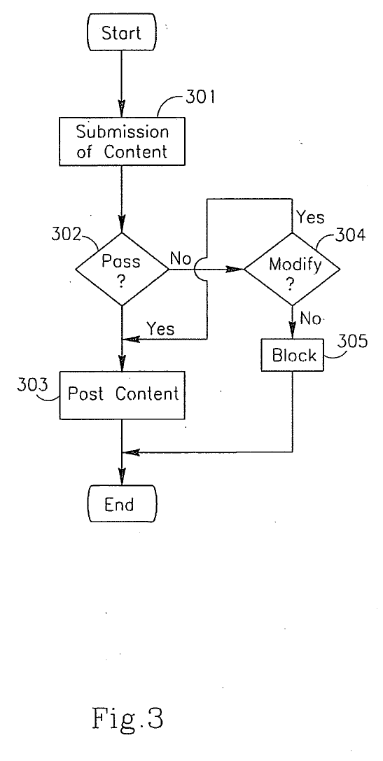

Referring now to FIG. 3, a high level flow chart of a copyrighted content posting method is shown and described according to an embodiment of the present disclosure. FIG. 3 will be described in association with FIG. 1. It is noted that users (for example Users 102 through 107 of FIG. 1) may forward (shown at 121) to Internet Content Company 101 content items even though the copyrights of these content items lawfully belong to Media Content 108. However, once such a content item is forwarded to Internet Content Company 101, Internet Content Company 101 may post or distribute it to the public (in the ways exemplified herein) only in accordance with the posting licensing agreement or licensing policy (“MDLS Definitions”, shown at 131) agreed-upon by both Internet Content Company 101 and the copyright issuer, which is, in the example shown in FIG. 1, Media Company 108.

Since it is assumed that users will not be motivated to forward unpopular content items, or derivatives thereof or other media derivatives, to Internet Content Company 101, the content items' pool held, owned and/or managed by, or associated with, Internet Content Company 101 will most likely contain content items and media derivatives that are relatively popular. Therefore, in accordance with the present disclosure Internet Content Company 101 does not have to deal with a large number of content items and media derivatives, some of which may be unpopular or even very unpopular. “Deal with” means buying content items and/or media derivatives from different media providing companies such as Media Company 108, paying their lawful copyright issuer(s) and posting them to users which may feel dissatisfied, and even hassled, because of them having to deal with (mostly deleting) unpopular content items or media derivatives.

At step 301 (“Submission of Content”) Internet content company such as Internet Content Company 101 may receive (shown at 121 in FIG. 1) content items and/or derivatives thereof, for example over a packet-switched network such as the Internet (not shown in FIG. 1), by one or more of Users 102 through 107 and/or by other users (not shown in FIG. 1). Internet Content Company 101 may have a storage array (not shown in FIG. 1) for storing content items that are provided (shown at 121 in FIG. 1) by users. For the reason described earlier, it is assumed that most, or at least a large number of the content items and/or content items derivatives provided to Internet Content Company 101 and stored in a storage array associated with it, are relatively popular.

At step 302 (“Pass ?”) Internet Content Company 101 may automatically determine, per received content item (or content item derivative), the availability of posting copyright, or if there is a posting copyright associated with it. That is, Internet Content Company 101 may automatically determine whether the received content item is a copyrighted piece of work (and therefore its posting should be a subject to certain predefined terms such as MDLS Definitions 131) or it can be distributed without the hassle of having to settle copyright issues. Internet Content Company 101 may automatically determine the availability of posting copyright, for example by determining the identity of the received content's copyright issuer (that is, if such an identity exists). According to an embodiment of the present disclosure a copyright issuer identifier may be an inherent part of, pre-assigned to, or be associated with, a copyrighted content item and/or copyrighted content item derivatives, and the copyright issuer identifier may be used by a content company such as Internet Content Company 101 of FIG. 1 to determine the availability of a posting copyright.

If Internet Content Company 101 determines, for a given content item or content item derivative, that a posting copyright is available, Internet Content Company 101 may check, at step 302, if the content item (or content item derivative) conforms to or satisfies MDLS Definitions 131. If the content item (or content item derivative) conforms to or satisfies (shown as “Yes” at step 302) MDLS Definitions 131, Internet Content Company 101 may post, at step 303 (“Post Content”), the involved (checked) content item (or content item derivative) to one or more users, for example to one or more of Users 102 through 107, in which case it may be said that the checked content item (or content items derivative) may pass through MDLS Filter 151. If, however, the content item (or content item derivative) checked at step 302 does not satisfy (shown as “No” at step 302) MDLS Definitions 131, it may be checked, at step 304 (“Modify ?”) whether the content item (or content item derivative) can be modified in such as way that the resulting modified content item (or content item derivative) will conform to or satisfy MDLS Definitions 131, Internet Content Company 101 may modify (shown as “Yes” at step 304) and thereafter post (at step 303) the resulting modified content item (or content item derivative). If, however, no modification (shown as “No” at step 304) of the content item (or media derivative) will conform or satisfy MDLS Definitions 131, the content item (or media derivative) will be blocked (“Block”, shown at step 305), meaning that the content item (or media derivative) will not be posted.

According to one aspect of the present disclosure a predetermined number of provided content items and/or content item derivatives may first be stored in the storage array of, or associated with, Internet Content Company 101, and thereafter individual content item and/or content item derivative may be posted if it conforms or satisfies MDLS Definitions 131. Alternatively or additionally, each content item and/or content item derivative may be posted the moment it is stored in the storage array, or a short while after it is stored in the storage array, regardless of the provision of other content items and/or content items derivatives.

It is noted that the flow chart of FIG. 3 is only an exemplary flow chart, as it may have less steps or more steps, each step may include less or more activities, decisions, and so on, than is described or demonstrated herein.

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure.

What is claimed is:

1. A method of posting online content items and media derivatives comprising:
receiving a content item or media derivative;
determining availability of posting copyright for the content item or media derivative; and
posting the content item or media derivative, or a modification thereof, according to a posting licensing policy associated with an available posting copyright.

2. The method according to claim 1, wherein determining comprises determining an identity of the copyright issuer associated with the received content or media derivative.

3. The method according to claim 1, wherein determining availability of posting copyright comprises determining whether a received content item or media derivative conforms to one or more restrictions specified in the posting licensing policy.

4. The method according to claim 3, further comprising modifying a content item or media derivative to comply with the restriction(s) specified in the posting licensing policy.

5. The method according to claim 1, further comprising posting a media derivative of a content item if the media derivative conforms to restriction(s) set forth in the posting licensing policy.

6. The method according to claim 5, wherein a content item or a media derivative is posted to users directly or through a retailer.

7. The method according to claim 6, wherein a retailer comprises a mobile phone company, television broadcasting network, interactive television providing company, Internet web site or any combination thereof.

8. The method according to claim 2, further comprising sending posting reports to respective copyright issuers.

9. The method according to claim 1, wherein availability of posting copyright or the identity of a copyright issuer is determined automatically.

10. A content posting system comprising:
a communication module adapted to receive a content item and media derivative; and
a copyright clearance module adapted to determine availability of posting copyright associated with the content item or media derivative, and post the content item or media derivative, or a modification thereof, according to a posting licensing policy associated with an available posting copyright.

11. The system according to claim 10, wherein determine comprises determining an identity of a copyright issuer associated with the received content item or media derivative.

12. The system according to claim 10, wherein said copyright clearance module is further adapted to determine whether a content item or media derivative conforms to one or more restrictions specified in the posting licensing policy.

13. The system according to claim 10, further comprising a posting module adapted to post content items and media derivatives if copyright is available.

14. The system according to claim 13, wherein said posting module is further adapted to post content items and media derivatives if they conform to one or more restrictions specified in, or imposed by, the posting licensing policy.

15. The system according to claim 10, wherein said copyright clearance module is further adapted to modify a content item, media derivative of a content item or both according to one or more restrictions defined in the posting copyright.

16. The system according to claim 13, wherein said posting module is adapted to post a content item or a derivative thereof to users directly or through a retailer.

17. The system according to claim 16, wherein a retailer comprises a mobile phone company, television broadcasting network, interactive television providing company, Internet web site or any combination thereof.

18. The system according to claim 13, wherein said copyright clearance module is further adapted to send a posting report to respective copyright issuers.

19. The system according to claim 11, wherein said copyright clearance module is further adapted to automatically determine availability of posting copyright or the identity of a copyright issuer.
